(19) United States
(12) Patent Application Publication
(10) Pub. No.: US 2001/0046897 A1
(43) Pub. Date: Nov. 29, 2001

(54) Steering wheel type controller

(75) Inventors: Yasuji Hagiwara, Fukushima-ken (JP); Masahiro Soma, Fukushima-ken (JP); Youtaro Sakakura, Fukushima-ken (JP); Hiroshi Nakahama, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/819,396

(22) Filed: Mar. 28, 2001

(30) Foreign Application Priority Data
May 24, 2000 (JP) 2000-152574

(51) Int. Cl. A63F 13/02

(52) U.S. Cl. 463/37

(57) ABSTRACT

A controller is provided with a steering wheel, a support, and an actuator served as the driving means. The steering wheel is provided with a slide body that is slidable in the body of the support, and the slide body is supported slidably in the direction perpendicular to the rotational direction of the steering wheel. A fixed member of the actuator is fixed to the body, and a movable member of the actuator is fixed to back side of the slide body. The steering wheel is reciprocated in the direction perpendicular to the rotational direction of the steering wheel by controlling the actuator correspondingly to the control signal supplied from the control unit.

### BACKGROUND OF THE INVENTION

1. Field of the Invention

This invention relates to a steering wheel type controller used for simulation of vehicles such as automobiles.

2. Description of Related Art

For example, so-called game pad comprising a box having a plurality of switches, and operated by hand has been used as a controller used for gaming. The controller of this type is usable widely for operation of various game applications.

In games for simulating a vehicle or an air plane, controllers that are similar to actual steering wheel or control stick are commercially available to improve the realistic sensation of the game.

For example, the conventional controller used for the simulation game such as car race simulation game is loaded with rotation load to a steering wheel correspondingly to the road condition to express the realistic sensation. For example, when the frictional resistance on the road surface with which tires are in contact is high, the rotational load required to rotate a steering wheel is increased to be hard to be rotated.

When a vehicle is driven on a bad rough road, the steering wheel is vibrated by means of a vibration generation means provided in the steering wheel to give the vibration to an operator. A vibration generation means in which vibration is generated by rotating a motor having an eccentric weight on the shaft mounted in a steering wheel has been used.

However, the above-mentioned conventional game controller does not reproduce the situation of actual vehicle running with fidelity.

In detail, the above-mentioned means for vibrating by use of the motor cannot cause the sufficient vibration and the vibration is insufficient for increasing the realistic sensation. Furthermore, the above-mentioned means in which the rotational load is transmitted to the steering wheel cannot give the realistic sensation of the shock that would be caused when, for example, a vehicle bounds and lands against the ground.

### SUMMARY OF THE INVENTION

The present invention has been accomplished to solve the above-mentioned problem, and it is the object of the present invention to provide a steering wheel type controller used as a vehicle running simulation controller that is capable of reproducing the motion of the steering wheel with fidelity corresponding to the state of the road and vehicle body to thereby improve the realistic sensation.

The present invention provides a controller having a steering wheel for controlling the direction of a vehicle body displayed on a screen and a support for supporting the steering wheel rotatably, wherein the support is provided with a driving means for driving the steering wheel in the direction intersecting the rotational direction of the steering wheel, and a control unit for controlling the driving force transmitted from the driving means to the steering wheel by supplying a signal to the driving means.

For example, the steering wheel is supported movably in the direction perpendicular to the rotational direction with respect to the support, and driven by the driving means so as to be reciprocated in the perpendicular direction.

Otherwise, the steering wheel is supported rotatably in the direction intersecting the rotation direction with respect to the support, and driven by the driving means so that the steering wheel is swung.

The driving means is constituted by a solenoid mechanism. A load generation means for loading a load in the rotational direction of the steering wheel may be provided.

Differently from the conventional controller in which only the small vibration and the rotational load in the rotational direction of a steering wheel are generated, in the case of a controller of the present invention, a steering wheel is reciprocated in the direction perpendicular to the steering wheel, the motion corresponding to the change of the state of the road and vehicle body is reproduced with fidelity, and the realistic sensation of the game is improved.

The steering wheel type controller of the present invention can be applied to operation or maneuvering simulation system in addition to the game simulation.

### BRIEF DESCRIPTION OF THE DRAWINGS

FIG. 1 is a perspective view illustrating a steering wheel type controller of the present invention.

FIG. 2 is a cross sectional view along the line 2-2 of FIG. 1.

FIG. 3 is a cross sectional view along the line 3-3 of FIG. 2.

FIG. 4 is a block diagram illustrating the internal structure of the controller.

FIG. 5 is a perspective view illustrating another controller of the present invention.

### DETAILED DESCRIPTION OF THE PREFERRED EMBODIMENTS

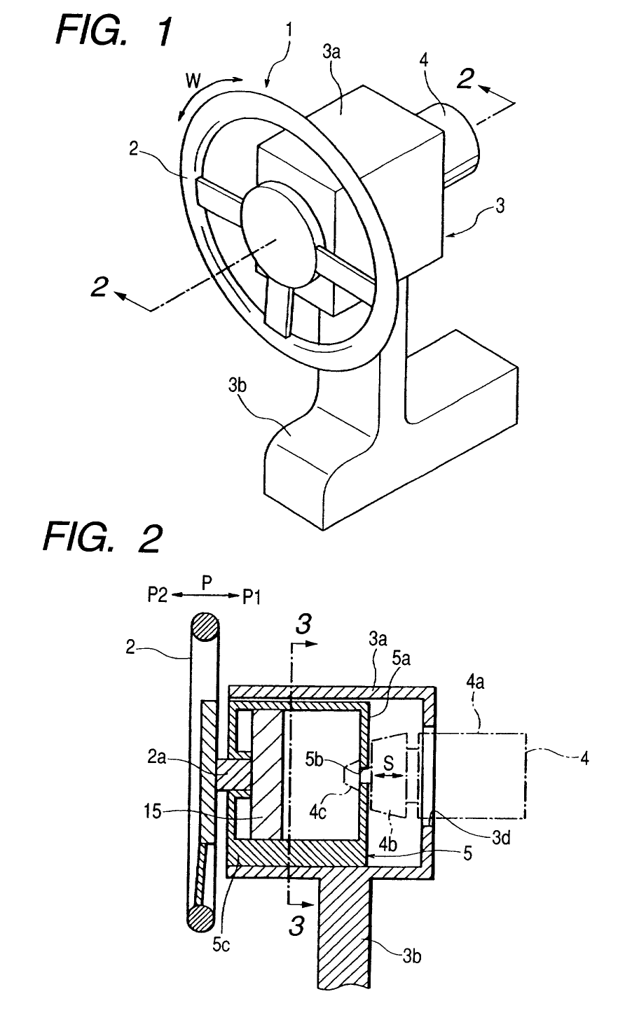

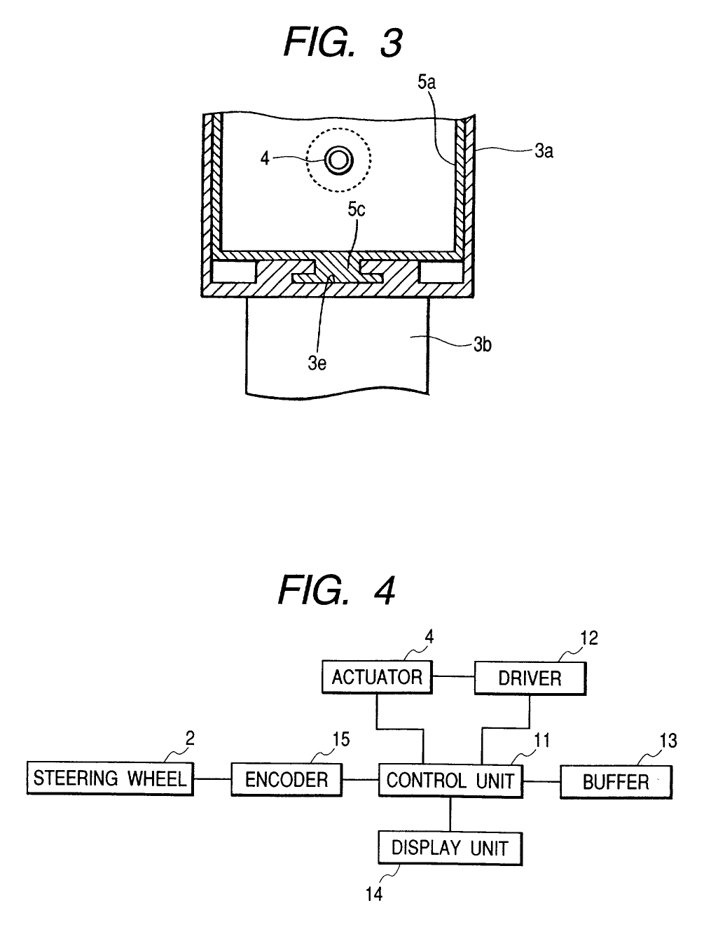

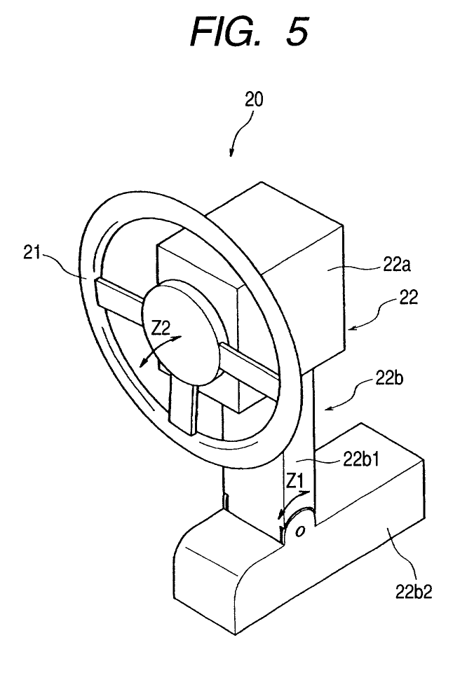

FIG. 1 is a perspective view illustrating the apparent of a controller of the present invention, FIG. 2 is a cross sectional view along the line 2-2 of FIG. 1, FIG. 3 is a cross sectional view along the line 3-3 of FIG. 2, and FIG. 4 is a functional block diagram illustrating the internal structure of the controller.

The controller 1 shown in FIG. 1 can be used for vehicle simulation game such as car race. The controller 1 is provided with a steering wheel 2 that an operator holds with hands for operation, a support 3 that supports the steering wheel 2 rotatably in the direction W, an encoder 15 for detecting the magnitude of rotation and rotational speed of the steering wheel 2, and an actuator 4 that is served as a driving means.

The above-mentioned controller 1 is connected to a game machine body in the case of a home game machine, and the game machine body is connected to a home television receiver (display unit) for using. The desired motion is given to the steering wheel 2 correspondingly to the screen of the display unit, namely the state of the road where a vehicle is running and the state of the vehicle body. Otherwise, the above-mentioned controller 1 may be connected to a personal computer for using. In this case, the controller 1 is connected to the assigned port of the computer body, a display that is the built-in display of the computer or provided separately from the computer body is used as the display unit, and the desired motion is given to the steering wheel 2 correspondingly to the state of the screen displayed on the display unit. Furthermore, the above-mentioned controller 1 may be attached to a large-sized game machine installed in an amusement facility.

The support 3 comprises a body 3a that supports the steering wheel 2 rotatably and a leg 3b extending from the body 3a downward that fixes the steering wheel 2 at the desired height and angle. The size and configuration of the leg 3b may be changed desiredly.

As shown in FIG. 2, a space is formed in the internal of the body 3a, and a slide body 5 is contained in the space. The slide body 5 is provided fixedly with an encoder 15 for detecting the rotational magnitude and rotational speed, and the rotational operation input is given to the encoder 15 through the shaft 2a of the steering wheel 2.

The slide body 5 has a box-shaped case 5a that is accommodable in the body 3a, and a through hole 5b having a small diameter is formed on the back side of the case 5a. A movable portion of the actuator 4 is fixed to the through hole 5b. A mounting hole 3d to which the actuator 4 is to be mounted is formed on the back side of the body 3a.

A projection 5c for sliding in the body 3a is formed on the bottom of the slide body 5. The projection 5c is formed extending to the direction perpendicular to the rotational direction W of the steering wheel 2 (front/rear direction), and formed projectingly downward from the bottom center of the slide body 5 as shown in the cross sectional view of FIG. 3. The projection 5c has the end that is reverse T-shaped.

On the other hand, a groove 3e that supports the projection 5c slidably is formed on the body 3a. In detail, the groove 3e is formed extending in P direction perpendicular to the rotational direction W of the steering wheel so that the recess is fitted engagingly to the reverse T-shaped projection 5c as shown in FIG. 3. Thereby, the projection Sc is slidable along the groove 3e without rattle. Because the slide body 5 is slidable in the body 3a, the steering wheel is movable in the front/rear direction (P direction).

The actuator 4 has a solenoid mechanism comprising an approximately cylindrical fixed member 4a and a movable member 4b. The fixed member (base end) 4a is fixed to the mounting hole 3d of the body 3a by means of screwing, and the movable member (other end) 4b is fixed to the back side of the case 5a. The through hole 5b is formed on the back side of the case 5a, and the top end of the movable member 4b is inserted into the through hole 5b. The top end is fixed with a fixing member 4c having a diameter larger than that of the through hole 5b.

The movable member 4b of the actuator 4 is formed of magnetic material such as iron so as to act as a plunger. The plunger of the movable member 4b is inserted in the fixed member 4a of the actuator 4. In the internal of the fixed member 4a of the actuator, a coil for attracting the plunger magnetically, a magnetic core around which the coil is wound, and a rear counter core formed in one piece together with the magnetic core for attracting the rear end of the plunger are provided. Furthermore, a coil spring for pushing out the movable member 4b toward the operator side when the solenoid is not excited is provided.

As shown in FIG. 4, the controller 1 is provided with the steering wheel 2, the encoder 15, a control unit 11, the actuator 4, a solenoid driver 12, a buffer 13, and a display unit 14. The control unit 11 is served for controlling the reading of a game program read from, for example, a CD or DVD, for controlling the image displayed on the display unit 14, and for controlling the operation to give the desired signal to the steering wheel 2 by driving the actuator 4 based on the image.

In game operation, when the steering wheel 2 is rotated, the output from the encoder 15 is transmitted to the control unit 11 and the game content is operated, and the content is displayed on the display unit 14.

When, for example, a vehicle body bounds and lands against the ground depending on the state of the road and vehicle body displayed on the screen of the display unit 14, a control signal is supplied from the control unit 11 to the driver 12, the actuator 4 is excited, the movable member 4b is attracted against the pushing force of the coil spring. At that time, the steering wheel 2 moves in P1 direction in FIG. 2 with sliding of the slide body 5 in the body 3a of the support 3. Furthermore, the control signal is supplied from the control unit 11 to the driver 12 so that the actuator 4 is turned to no excitation, and the movable member 4b is projected by the pushing force of the coil spring. At that time, the steering wheel 2 moves in P2 direction in FIG. 2 with sliding of the slide body 5 in the body 3a.

The excitation and no excitation of the actuator 4 are repeated as described hereinabove, and the steering wheel 2 is concomitantly reciprocated continuously in P direction.

FIG. 5 is a perspective view illustrating another steering wheel type controller 20 of the present invention.

The controller 20 shown in FIG. 5 is provided with a steering wheel 21 and a support 22 that supports the steering wheel 21 rotatably. The support 22 comprises a body 22a and a leg 22b, and the leg 22b has a foot 22b1 extending in the vertical direction and a base 22b2 that supports the foot 22b1. The top end of the foot 22b1 is fixed to the body 22a, and the bottom end is supported rotatably in Z1 direction by the base 22b2. Therefore, the steering wheel 21 is rotatable in Z2 direction.

A solenoid mechanism may be used as the means for rotating the steering wheel 21 as in the above-mentioned case.

The steering wheel type controller of the present invention is by no means limited to the above-mentioned embodiments, and, for example, the foot 22b1 may be slidable in the front/rear direction on the base 22b2. Furthermore, a load generation means for loading a load in the rotational direction of a steering wheel may be provided to improve the realistic sensation the more.

The present invention described hereinbefore is suitably applied for vehicle operation simulation controllers, and a steering wheel is reciprocated in the direction perpendicular to the rotational direction of the steering wheel. Thereby, the motion that would be sensed when a vehicle is operated actually, which cannot be sensed by use of the conventional controller, is reproduced with fidelity.

What is claimed is:

1. A controller comprising a steering wheel for controlling the direction of a vehicle body displayed on a screen and a support for supporting the steering wheel rotatably, wherein the support is provided with a driving means for driving the steering wheel in the direction intersecting the rotational direction of the steering wheel, and a control unit for controlling the driving force transmitted from the driving means to the steering wheel by supplying a signal to the driving means.

2. The controller according to claim 1, wherein the steering wheel is supported movably in the direction perpendicular to the rotational direction with respect to the support, and driven by the driving means so as to be reciprocated in the perpendicular direction.

3. The controller according to claim 1, wherein the steering wheel is supported rotatably in the direction intersecting the rotation direction with respect to the support, and driven by the driving means so that the steering wheel is swung.

4. The controller according to claim 1, the driving means is a solenoid mechanism.

5. The controller according to claim 1, wherein a load generation means for loading a load in the rotational direction of the steering wheel is provided.
